(19) United States
(12) Patent Application Publication
(10) Pub. No.: US 2019/0080196 A1
(43) Pub. Date: Mar. 14, 2019

(54) METHOD OF MASKING OBJECT OF NON-INTEREST

(71) Applicant: SAMSUNG SDS CO., LTD., Seoul (KR)

(72) Inventors: Jung Ah CHOI, Seoul (KR); Sang Hak LEE, Seoul (KR); Jin Ho CHOO, Seoul (KR); Jong Hang KIM, Seoul (KR); Jeong Seon YI, Seoul (KR); Ji Hoon KIM, Seoul (KR); Ji Young CHOI, Seoul (KR)

(73) Assignee: SAMSUNG SDS CO., LTD., Seoul (KR)

(21) Appl. No.: 16/115,908

(22) Filed: Aug. 29, 2018

(30) Foreign Application Priority Data
Sep. 8, 2017 (KR) 10-2017-0115149

(51) Int. Cl. G06K 9/32; G06K 9/40; G06K 9/44; G06K 9/00; G06T 7/246

(52) U.S. Cl. CPC G06K 9/3233; G06K 9/40; G06K 9/44; G06T 2207/30196; G06T 7/246; G06T 2207/10016; G06T 2207/20036; G06K 9/00744

(57) ABSTRACT

There is provided a method of masking an object of non-interest by a masking apparatus. The method comprises acquiring first video information of a region of interest, determining a first object of non-interest area as an area in which motion vectors are present in the first video information of the region of interest, removing spatial noise from the first object of non-interest area to acquire a second object of non-interest area including at least a part of the first object of non-interest area and generating a mask corresponding to the second object of non-interest area.

This application claims priority from Korean Patent Application No. 10-2017-0115149 filed on Sep. 8, 2017, in the Korean Intellectual Property Office, the disclosure of which is incorporated herein by reference in its entirety.

### BACKGROUND

### 1. Field of the Disclosure

The present disclosure relates to a method of masking an object of non-interest, and more particularly, to a method of determining an object of non-interest area to be masked in input image information and improving the accuracy and reliability of object-of-interest detection through masking and an apparatus for performing the method.

### 2. Description of the Related Art

An intelligent video analysis system denotes a system that analyzes in real time video information collected from a video capturing device, such as a closed circuit television (CCTV), to detect, track, and recognize an object of interest and provides various kinds of analysis information. With the proliferation of CCTVs and the advancement of video analysis technology, intelligent video analysis systems are currently being built and used in various fields. For example, intelligent video analysis systems are being built and used in various stores for the purpose of acquiring business intelligence information such as customers' lines of flow.

Among a series of video analysis tasks performed by an intelligent video analysis system, object-of-interest detection may be the most fundamental process in video analysis and the most important task for ensuring the reliability of analysis information. In general, an object of interest is an object that moves, such as a customer. Accordingly, an intelligent video analysis system detects an object of interest on the basis of a movement feature extracted from a video.

In such an object-of-interest detection process, accuracy in object-of-interest detection is mainly degraded because objects of non-interest with movement are misdetected as objects of interest. For example, when video analysis information of customers' lines of flow in a display store shown in FIG. 1A is provided in the form of a heat map, arranged display devices may be misdetected as objects of interest due to movement in videos played in the display devices. In the heat map shown in FIG. 1B, a rectangular area 10 indicates an area in which display devices are misdetected as objects of non-interest. Like this, when an object of non-interest with movement is misdetected as an object of interest, the reliability of analysis information provided as intelligent video analysis results may be significantly degraded in the end, and thus it is necessary to find a solution thereto.

To solve this problem, a manager sets an area in which an object of non-interest exists as an exceptional area in many cases. However, this method in which a manager manually sets an exceptional area involves setting an exceptional area again whenever a region of interest is changed, and thus is inconvenient. Also, it is highly likely that an exceptional area will be incorrectly set, and when an exceptional area is incorrectly set, the reliability of analysis information may be further degraded.

Consequently, it is necessary to develop a method of improving accuracy in object-of-interest detection by automatically detecting an area in which an object of non-interest exists and masking the detected area.

### SUMMARY

Aspects of the present disclosure provide a masking method for improving accuracy in object-of-interest detection by masking an object of non-interest in input video information, and an apparatus for performing the method.

Aspects of the present disclosure also provide a method of accurately detecting an area in which an object of non-interest exists in input video information and generating a mask corresponding to the detected area, and an apparatus for performing the method.

Aspects of the present disclosure also provide a method of accurately detecting an object of interest included in input video information by using a generated mask, and an apparatus for performing the method.

It should be noted that objects of the present disclosure are not limited to the above-described objects, and other objects of the present disclosure will be apparent to those skilled in the art from the following descriptions.

According to an aspect of the present disclosure, there is provided a method of masking an object of non-interest by a masking apparatus, the method comprising acquiring first video information of a region of interest, determining a first object of non-interest area as an area in which motion vectors are present in the first video information of the region of interest, removing spatial noise from the first object of non-interest area to acquire a second object of non-interest area including at least a part of the first object of non-interest area; and generating a mask corresponding to the second object of non-interest.

According to another aspect of the present disclosure, there is provided a method of masking an object of non-interest by a masking apparatus, the method comprising acquiring a plurality of video frames of a region of interest, accumulating motion vectors acquired from the plurality of video frames, respectively, and determining a first object of non-interest area as an area in which the accumulated motion vectors are present, removing temporal noise from the first object of non-interest area based on lengths of the motion vectors to acquire a second object of non-interest area including at least a part of the first object of non-interest area and generating a mask corresponding to the second object of non-interest.

### BRIEF DESCRIPTION OF THE DRAWINGS

The above and other aspects and features of the present disclosure will become more apparent by describing in detail exemplary embodiments thereof with reference to the attached drawings, in which:

FIGS. 1A and 1B are diagrams illustrating a problem that objects of non-interest are misdetected as objects of interest;

FIG. 2 shows a configuration of an intelligent video analysis system according to an exemplary embodiment of the present disclosure;

FIGS. 3 and 4 are diagrams illustrating a schematic configuration and operation of a masking apparatus according to an exemplary embodiment of the present disclosure;

FIG. 5 is a block diagram of a mask generator of a masking apparatus according to a first exemplary embodiment of the present disclosure;

FIGS. 6 to 7B are diagrams illustrating a motion vector refiner shown in FIG. 5;

FIG. 8 is a diagram illustrating a motion vector accumulator shown in FIG. 5;

FIG. 9 is a block diagram of a spatial noise remover shown in FIG. 5;

FIGS. 10 to 13 are diagrams illustrating a first spatial noise remover shown in FIG. 9;

FIGS. 14 and 15B are diagrams illustrating a second spatial noise remover shown in FIG. 9;

FIG. 16 shows diagrams illustrating a third spatial noise remover shown in FIG. 9;

FIGS. 17 and 18 are diagrams illustrating a masking apparatus according to a second exemplary embodiment of the present disclosure;

FIGS. 19 to 22 are diagrams illustrating a masking apparatus according to a third exemplary embodiment of the present disclosure;

FIG. 23 is a diagram showing a hardware configuration of a masking apparatus according to another exemplary embodiment of the present disclosure;

FIGS. 24 to 26 are flowcharts illustrating a mask generation method according to an exemplary embodiment of the present disclosure;

FIGS. 27 and 28 are flowcharts illustrating an object-of-interest detection method according to an exemplary embodiment of the present disclosure; and

FIGS. 29A and 29B are diagrams comparatively illustrating a case in which masking has not been performed and a case in which a masking method according to an exemplary embodiment of the present disclosure has been performed.

### DETAILED DESCRIPTION OF THE EMBODIMENTS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims. Like numbers refer to like elements throughout.

Unless otherwise defined, all terms including technical and scientific terms used herein have the same meaning as commonly understood by one of ordinary skill in the art to which this disclosure belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Before description of this specification, some terms used herein will be clarified.

In this specification, a region of interest denotes a region which is filmed by a video capturing apparatus to acquire analysis information related to a purpose of video analysis. Here, the region denotes a physical space or a geographic space in the real world. For example, when a user intends to acquire business intelligence information such as the lines of flow, residence times, etc. of customers in a store, the store may be a region of interest.

In this specification, an object of interest denotes an object which will be detected in an input video. Here, the object may be interpreted as a comprehensive meaning encompassing anything that may be given meanings such as a person, an animal, and a plant.

In this specification, an object of non-interest denotes an object that is not the object of interest in the input video. In other words, the object of non-interest may be interpreted as a meaning including all objects other than a detection target in the input video. For example, when objects of interest are people, objects of non-interest may denote all objects other than people in the input video. In general, an object of interest is detected on the basis of a movement feature thereof, objects of non-interest with movement, such as a display apparatus in which a video is being played, a leaf swaying by wind, and a wave, may be misdetected as objects of interest.

In this specification, temporal noise denotes noise that temporarily occurs in the time domain. For example, when an input video is composed of a plurality of frames, the temporal noise may denote noise existing over some frames.

In this specification, spatial noise denotes noise that occurs in the spatial domain. In general, noise of a video may exist in a temporospatial domain, and causes of noise may be various such as a change in lighting and a sensor itself.

Hereinafter, some exemplary embodiments of the present disclosure will be described in detail with reference to the accompanying drawings.

FIG. 2 shows a configuration of an intelligent video analysis system according to an exemplary embodiment of the present disclosure.

An intelligent video analysis system according to an exemplary embodiment of the present disclosure may be configured to include an intelligent video analysis apparatus 100 and at least one video capturing apparatus 200 which films a region of interest. However, this is merely an exemplary embodiment for achieving objects of the present disclosure, and some components may be added or removed as necessary. Also, respective components of the intelligent video analysis system shown in FIG. 2 indicate functional elements which are functionally divided, and it is to be noted that at least two components may be integratively implemented in an actual physical environment. Each component of the intelligent video analysis system will be described below.

In the intelligent video analysis system, the intelligent video analysis apparatus 100 is a computing apparatus that receives video information of a region of interest from the video capturing apparatus 200 and performs intelligent video analysis on the basis of the video information. Here, the computing apparatus may be a tablet, a desktop, a laptop, and the like. However, the computing apparatus is not limited thereto and may include any kind of apparatuses having a calculation means and a communication means. When the intelligent video analysis apparatus 100 operates to analyze video information in real time, the computing apparatus may be implemented as a high-performance server computing apparatus.

The intelligent video analysis apparatus 100 may perform detection, tracking, etc. of an object of interest on the basis of the received video information and provide various kinds of analysis information, such as people counting information and customers' line-of-flow information, on the basis of the detection, tracking, and the like. To improve information transferability, the analysis information may be provided in a visualized form like a heat map.

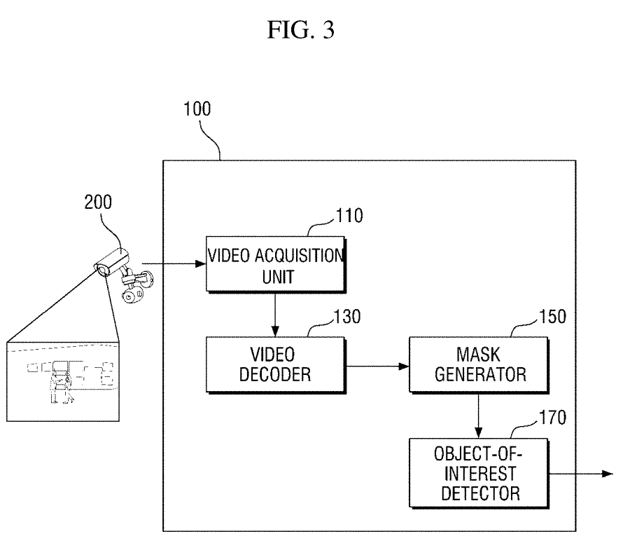

According to an exemplary embodiment of the present disclosure, the intelligent video analysis apparatus 100 determines an object of non-interest area on the basis of a motion vector acquired from first video information of a region of interest, and removes temporal and/or spatial noise from the object of non-interest area. Also, the intelligent video analysis apparatus 100 generates a mask corresponding to the object of non-interest area from which noise has been removed, and detects an object of interest in second video information of the region of interest by using the generated mask. In such an exemplary embodiment, the intelligent video analysis apparatus 100 may be referred to as a masking apparatus for an object of non-interest. According to this exemplary embodiment, a mask of an object of non-interest area may be automatically generated without intervention of a manager. Therefore, a user's convenience may be improved. Also, since masking of an object of non-interest area prevents an object of non-interest from being misdetected as an object of interest, accuracy in object-of-interest detection may be improved. This exemplary embodiment will be described in detail with reference to FIG. 3 and subsequent drawings.

In the intelligent video analysis system, the video capturing apparatus 200 is an apparatus that generates and provides video information of a designated region of interest to the intelligent video analysis apparatus 100. The video capturing apparatus 200 may be implemented as, for example, a closed circuit television (CCTV) but may be implemented as any apparatus capable of acquiring video information of a designated region of interest.

According to an exemplary embodiment of the present disclosure, the video capturing apparatus 200 may perform an encoding processing on generated video information and provide video information to the intelligent video analysis apparatus 100 in the form of a bitstream. The encoding processing may be performed on the basis of a block matching algorithm, and a motion vector which has been calculated in certain units of blocks may be acquired as a result of performing the block matching algorithm. Since the motion vector calculated through the encoding processing is included in the video information and transmitted, the intelligent video analysis apparatus 100 may acquire the motion vector through a decoding processing without additional calculation. Therefore, it is possible to reduce time and computing costs for the intelligent video analysis apparatus 100 to calculate a motion vector. For convenience of description, a motion vector calculated in an encoding process will be referred to as a “first motion vector” below.

In the intelligent video analysis system shown in FIG. 2, each component may communicate via a network. Here, the network may be implemented as any kind of wired/wireless networks such as a local area network (LAN), a wide area network (WAN), a mobile radio communication network, and a wireless broadband Internet (WiBro) network.

An intelligent video analysis system according to an exemplary embodiment of the present disclosure has been described above with reference to FIG. 2. A configuration and operation of a masking apparatus 100 for an object of non-interest according to an exemplary embodiment of the present disclosure will be described with reference to FIGS. 3 to 23.

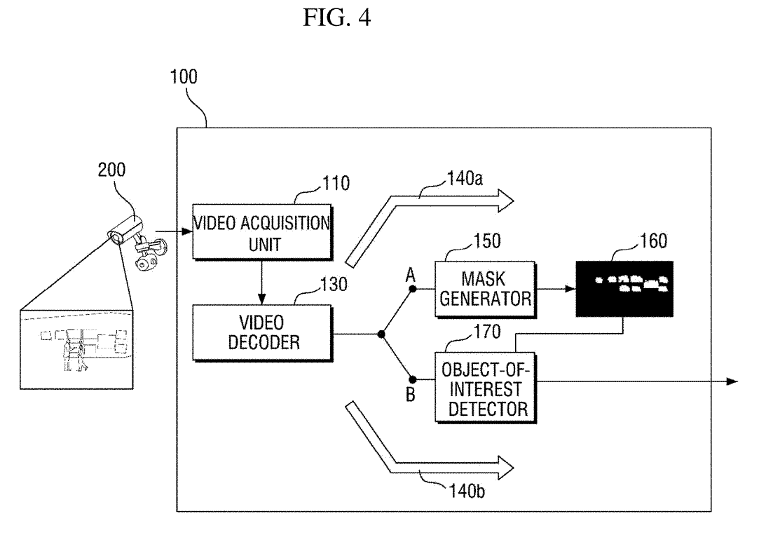

First, a schematic configuration and operating method of the masking apparatus 100 for an object of non-interest will be briefly described with reference to FIGS. 3 and 4, and configurations and operations of masking apparatuses 100-1 to 100-4 according to various exemplary embodiments of the present disclosure will be described in detail with reference to subsequent drawings.

FIG. 3 is a block diagram showing the masking apparatus 100 for an object of non-interest according to an exemplary embodiment of the present disclosure.

Referring to FIG. 3, the masking apparatus 100 according to an exemplary embodiment of the present disclosure may be configured to include a video acquisition unit 110, a video decoder 130, a mask generator 150, and an object-of-interest detector 170. FIG. 3 only shows components related to an exemplary embodiment of the present disclosure. Therefore, those of ordinary skill in the art to which the present disclosure pertains should appreciate that general-use components other than those shown in FIG. 3 may be further included. Also, respective components of the masking apparatus 100 shown in FIG. 3 indicate functional elements which are functionally divided, and it is to be noted that at least two components may be integratively implemented in an actual physical environment.

Referring to each component, the video acquisition unit 110 acquires video information of a region of interest from the video capturing apparatus 200. Specifically, the video acquisition unit 110 acquires encoded video information in the form of a bitstream.

The video decoder 130 performs a decoding processing on the video information acquired in the form of a bitstream by the video acquisition unit 110. As a result of the decoding processing, the video decoder 130 may provide decoded video information and/or a first motion vector to the mask generator 150.

The mask generator 150 determines an object of non-interest area from the video information by using a motion vector and generates a mask corresponding to the object of non-interest area.

In a first exemplary embodiment, the mask generator 150 may determine an object of non-interest area by using the first motion vector.

In a second exemplary embodiment, the mask generator 150 may determine an object of non-interest area by using a motion vector which is calculated by the mask generator 150 on the basis of an optical flow. A motion vector which is calculated on the basis of an optical flow will be referred to as a “second motion vector” below so as to be distinguished from the first motion vector.

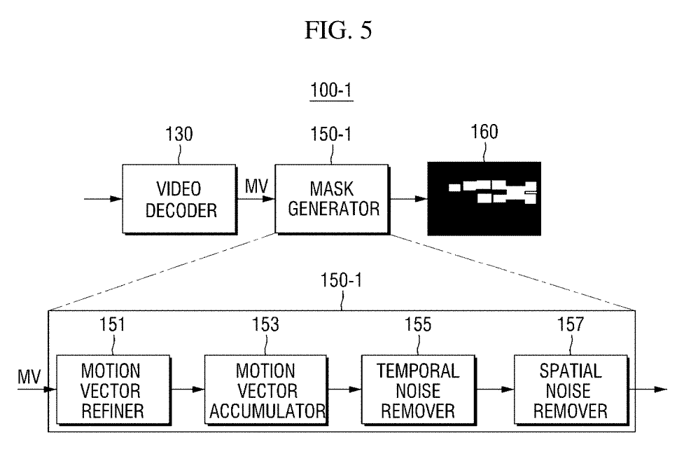

In a third exemplary embodiment, the mask generator 150 may determine an object of non-interest area by using both the first motion vector and the second motion vector. Operation of the mask generator 150 may vary according to an exemplary embodiment, and operation of the mask generator 150 according to each exemplary embodiment will be described in detail with reference to FIG. 5 and subsequent drawings.

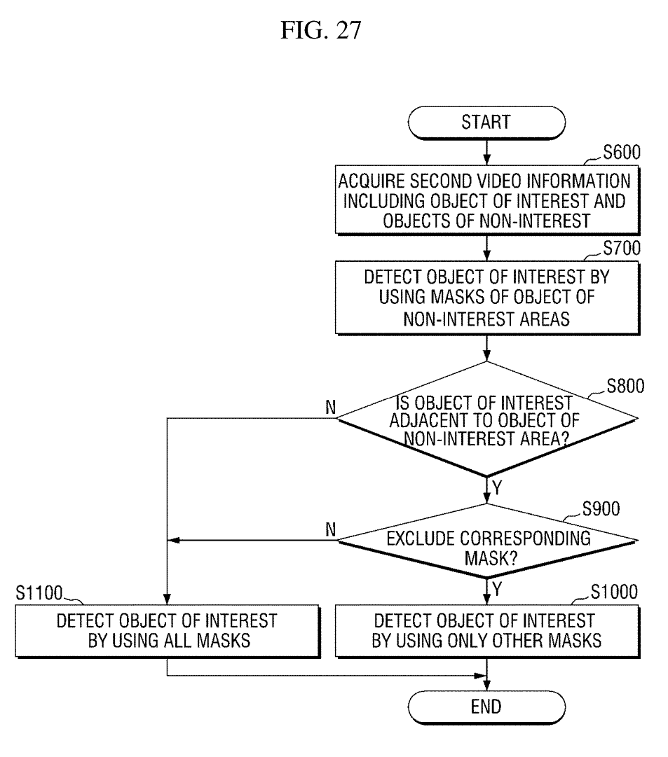

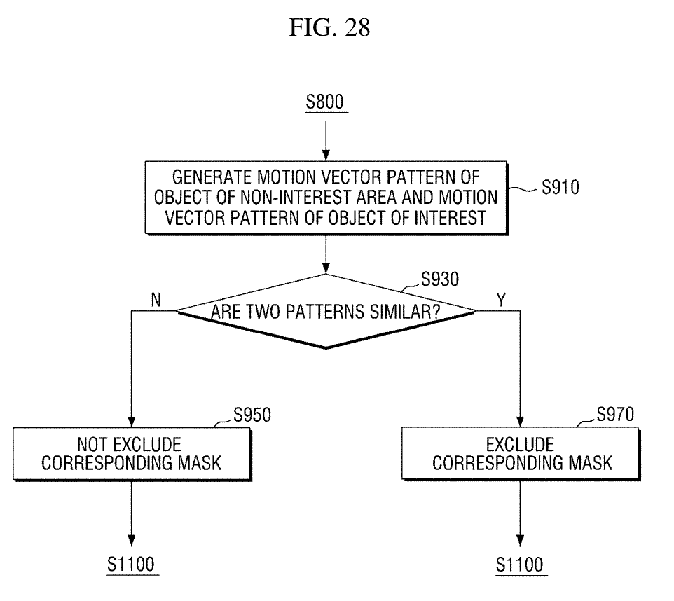

The object-of-interest detector 170 detects an object of interest by using the mask generated by the mask generator 150. Specifically, the object-of-interest detector 170 detects an object of interest in an area of the video information except for the object of non-interest area corresponding to the mask. An object-of-interest detection method performed by the object-of-interest detector 170 will be described below with reference to FIGS. 27 and 28.

Meanwhile, although not shown in FIG. 3, the masking apparatus 100 may be configured to further include a heat map generator (not shown). The heat map generator (not shown) generates a heat map in which movement of the object of interest detected by the object-of-interest detector 170 is visually represented. For example, the heat map generator (not shown) may generate a heat map by representing an area in which much movement of the object of interest is detected in a shade of red and representing an area in which little movement of the object of interest is detected in a shade of blue.

Each component of FIG. 3 may denote software or hardware such as a field programmable gate array (FPGA) or an application-specific integrated circuit (ASIC). However, the components are not limited to software or hardware and may be configured to reside in an addressable storage medium or to execute one or more processors. Functions provided in the components may be implemented by subdivided components, and a plurality of components may be integrated into one component which performs a specific function.

Next, an exemplary method of operating the masking apparatus 100 for an object of non-interest according to an exemplary embodiment of the present disclosure will be described with reference to FIG. 4.

Referring to FIG. 4, the masking apparatus 100 may be managed to generate a mask by using first video information among a plurality of pieces of video information and detect an object of interest from second video information on the basis of the generated mask.

More specifically, the masking apparatus 100 may generate a mask 160 for an object of non-interest area by using the first video information before detecting an object of interest. In this case, a mask generation operation is performed along a first path 140a in the masking apparatus 100.

According to an exemplary embodiment of the present disclosure, the first video information may be video information in which the least movement of an object of interest is detected or video information which is generated when no object of interest is shown. According to this exemplary embodiment, since an area in which movement of an object of interest is shown is prevented from being determined as an object of non-interest area, that is, an object of interest is prevented from being misdetected as an object of non-interest, an elaborate mask may be generated. Accordingly, accuracy of object-of-interest detection may be further improved.

Subsequently, the masking apparatus 100 detects an object of interest in the second video information by using the mask 160 generated from the first video information. In this case, an object-of-interest detection operation is performed along a second path 140b in the masking apparatus 100.

An exemplary method of operating the masking apparatus 100 according to an exemplary embodiment of the present disclosure has been described above with reference to FIG. 4. The masking apparatuses 100-1 to 100-4 according to some exemplary embodiments of the present disclosure will be described in detail below.

First, the masking apparatus 100-1 according to a first exemplary embodiment of the present disclosure will be described.

The masking apparatus 100-1 according to the first exemplary embodiment of the present disclosure determines an object of non-interest area by using a first motion vector calculated in an encoding process and generates a mask corresponding to the object of non-interest area. A configuration and operation of the masking apparatus 100-1 according to the first exemplary embodiment will be described below with reference to FIGS. 5 to 16.

FIG. 5 is a block diagram of a mask generator 150-1 which is a component of the masking apparatus 100-1 according to the first exemplary embodiment.

Referring to FIG. 5, the mask generator 150-1 may be configured to include a motion vector refiner 151, a motion vector accumulator 153, a temporal noise remover 155, and a spatial noise remover 157.

Referring to each component, the motion vector refiner 151 refines a first motion vector provided by the video decoder 130. In general, the first motion vector calculated in an encoding process includes various noises caused by a change in lighting, a camera sensor, and the like. Therefore, the motion vector refiner 151 is required to perform a certain refining process so as to minimize influence of the noises and accurately determine an object of non-interest area.

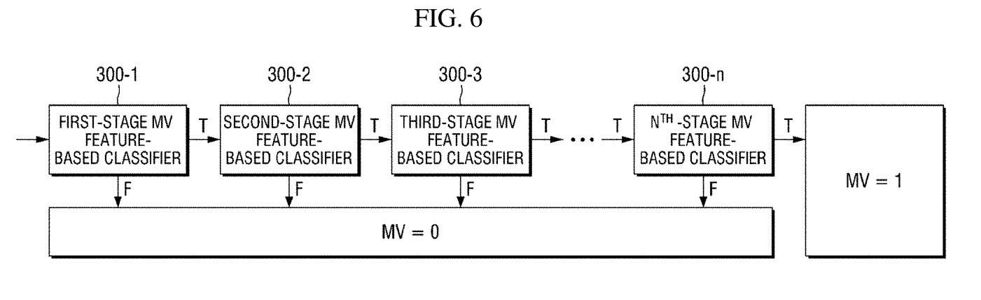

According to an exemplary embodiment of the present disclosure, the motion vector refiner 151 may refine the first motion vector by using a cascade classifier shown in FIG. 6. The cascade classifier determines whether a motion vector exists in a block to be classified by using a plurality of classifiers connected in sequence. To facilitate understanding, the cascade classifier will be described in further detail with reference to FIG. 6.

Referring to FIG. 6, the cascade classifier may include a first-stage classifier 300-1 based on a first feature of a motion vector to an nth-stage classifier 300-n based on an nth feature of the motion vector.

According to an exemplary embodiment of the present disclosure, features of a motion vector, which are classification criteria of stage-specific classifiers, may include a length of a motion vector in a block to be classified, whether a motion vector exists in neighboring blocks, a length of a motion vector in neighboring blocks, a direction of a motion vector in neighboring blocks, and the like.

As an example, the first-stage classifier 300-1 may determine that a motion vector exists in a block to be classified (MV=1) when the length of the block to be classified is a first threshold value or more, and may determine that no motion vector exists (MV=0) when the length of the block is less than the first threshold value. The second-stage classifier 300-1 may determine that a motion vector exists in the block to be classified when the length of the block to be classified is a second threshold value, which is set to be greater than the first threshold value, or less, and may determine that no motion vector exists when the length of the block is greater than the second threshold value. This is because, when a motion vector is too short or long in length, movement sensed from the corresponding block is highly likely to be noise.

As another example, the first-stage classifier 300-1 may determine that no motion vector exists in a block to be classified when the number of blocks having a motion vector therein is a threshold value or less among neighboring blocks adjacent to the block to be classified. Here, the neighboring blocks may be blocks positioned on the left, right, up, and down sides of the block to be classified or blocks positioned in a diagonal direction from the block to be classified. However, neighboring blocks are not limited thereto and may include neighboring blocks which are positioned within a certain distance from the block to be classified.

As another example, the first-stage classifier 300-1 may determine that no motion vector exists in a block to be classified when the number of blocks in which the length of a motion vector is a first threshold value or less or a second threshold value set to be greater than the first threshold value or more is a threshold value or more among the neighboring blocks adjacent to the block to be classified.

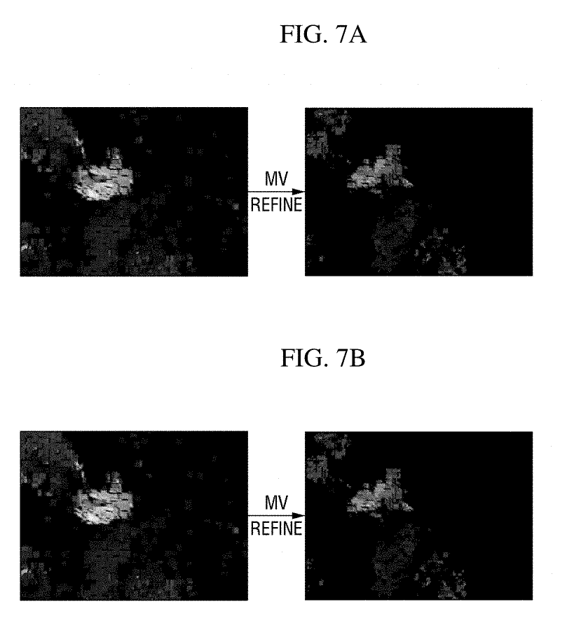

For reference, the cascade classifier shown in FIG. 6 is merely an exemplary embodiment of the present disclosure provided to facilitate understanding. The number and combination method of classifiers constituting the cascade classifier may vary without limit according to exemplary embodiments. Results of an experiment in which the motion vector refiner 151 refines a first motion vector by using the above-described cascade classifier are shown in FIGS. 7A and 7B.

Referring back to FIG. 5, other components of the mask generator 150-1 will be continuously described.

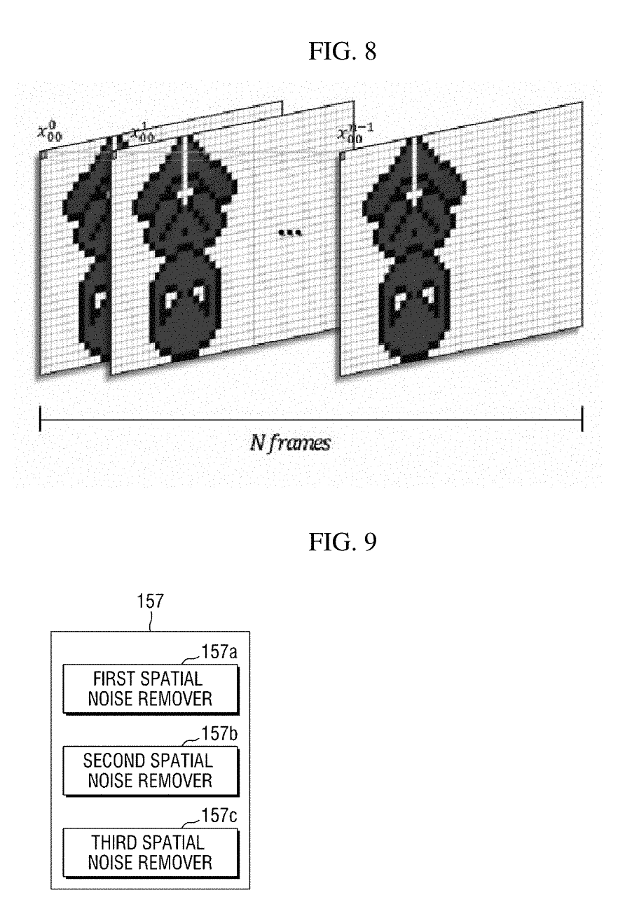

Referring to FIG. 5, the motion vector accumulator 153 accumulates motion vectors shown in a preset number of frames. Specifically, when the motion vector refiner 151 provides refined motion vectors in units of frames from video information including a plurality of frames, the motion vector accumulator 153 accumulates motion vectors shown in n (n is a natural number equal to or greater than 1) frames as shown in FIG. 8. The reason of accumulating motion vectors is that it is difficult to accurately determine an object of non-interest area with a motion vector shown in a single frame because objects of non-interest, such as a display apparatus in which a video is being played and a leaf swaying by wind, generally show less movement than an object of interest.

The value of n may be a preset fixed value or a variable value which varies according to circumstances. For example, the value of n may be a variable value which varies based on a size of an object of non-interest area or a change in the size. More specifically, when a size difference between an object of non-interest area, which is determined based on motion vectors accumulated to k frames, and an object of non-interest area, which is determined based on motion vectors accumulated to k+1 frames, is a threshold value or less, the value of n may be set to k.

Referring back to FIG. 5, the temporal noise remover 155 removes temporal noise from input video information. For example, the temporal noise remover 155 removes temporal noise from an area in which a first motion vector is present (will be referred to as a “1-1 object of non-interest area” below) in the input video information. For convenience of description, an object of non-interest area which is determined by removing temporal noise from the 1-1 object of non-interest area will be referred to as a “2-1 object of non-interest area” below.

Specifically, the temporal noise remover 155 determines the 2-1 object of non-interest area by excluding an area in which the average of motion vectors accumulated by the motion vector accumulator 153 is a threshold value or less from the 1-1 object of non-interest area. The average of accumulated motion vectors may be calculated as, for example, an arithmetic average based on uniform distribution but is not limited thereto.

Subsequently, the spatial noise remover 157 removes spatial noise from the input video information. For example, the spatial noise remover 157 removes spatial noise from the 2-1 object of non-interest area. However, when the mask generator 150-1 does not include the temporal noise remover 155 according to an exemplary embodiment, the spatial noise remover 157 may remove spatial noise from the 1-1 object of non-interest area. For convenience of description, an object of non-interest area which is determined by removing spatial noise from the 2-1 object of non-interest area will be referred to as a “3-1 object of non-interest area” below.

The spatial noise remover 157 may be configured to include at least one of first to third spatial noise removers 157a to 157c which remove spatial noise in different ways. According to exemplary embodiments, the first to third spatial noise removers 157a to 157c may be combined in various ways. As an example, FIG. 9 shows a case in which the spatial noise remover 157 is configured to include all the first to third spatial noise removers 157a to 157c. Each component of the spatial noise remover 157 will be described below.

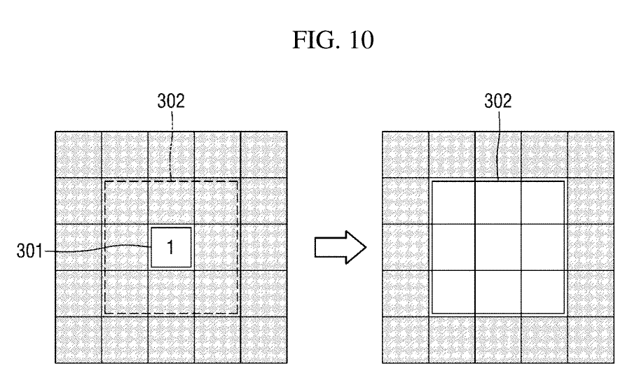

The first spatial noise remover 157a removes spatial noise by expanding areas in units of pixels. Specifically, the first spatial noise remover 157a removes spatial noise through an area expansion processing of expanding a pixel area 301 in which a motion vector is present to an area 302 having a preset size as shown in FIG. 10. As an example, FIG. 10 shows a case in which the area having the preset size is a d×d square area and d is 3, but the value of d and the shape of the area may vary without limit.

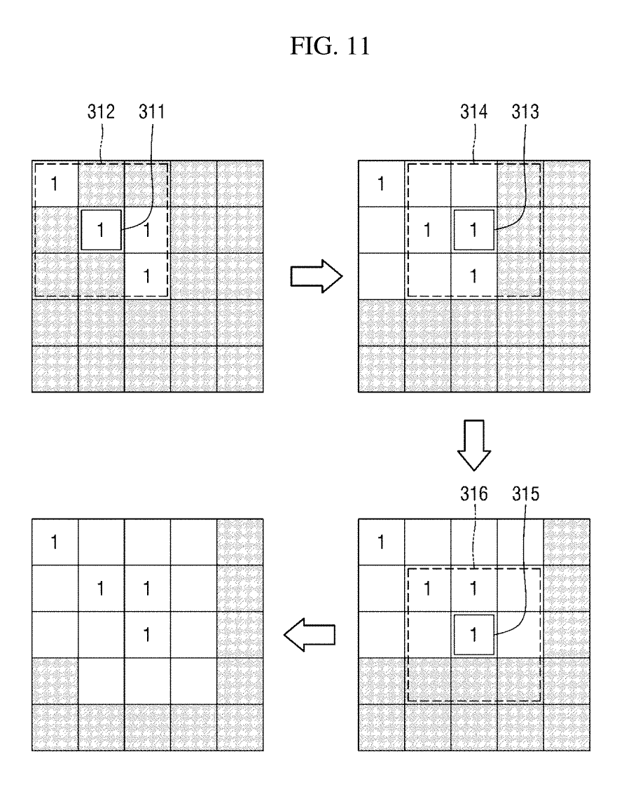

The area expansion processing is performed on each pixel included in the 2-1 object of non-interest area. For example, as shown in FIG. 11, an area expansion processing may be performed on a first pixel 311 included in the 2-1 object of non-interest area, which indicates an area in which a motion vector exists, and an area expansion processing may be continuously performed on each of a second pixel 313, a third pixel 315, and the like.

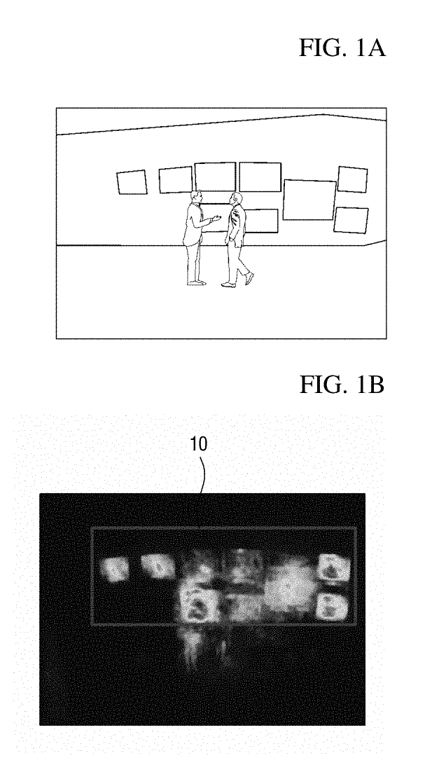

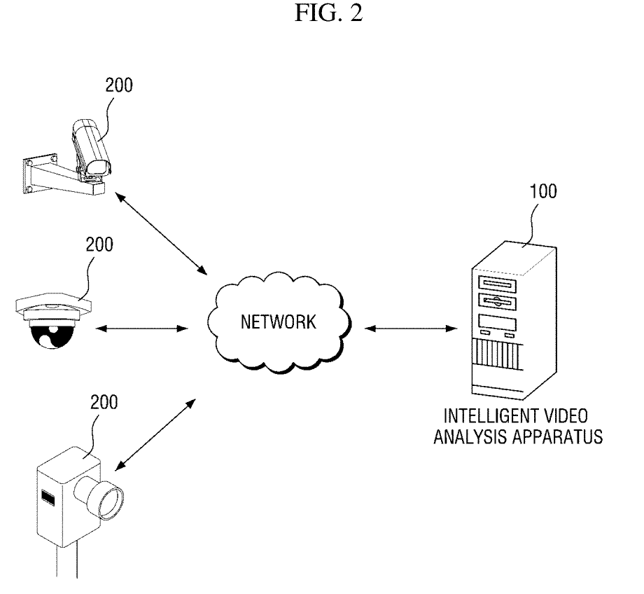

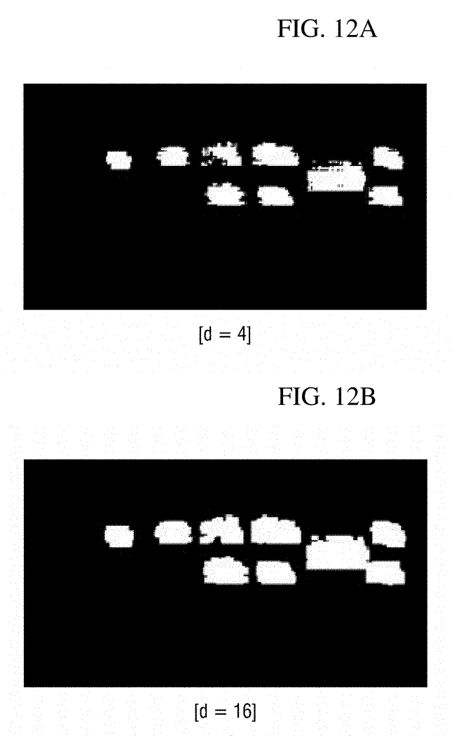

FIGS. 12A and 12B show results of performing an area expansion processing on video information shown in FIG. 1A. FIGS. 12A and 12B show cases in which an area having a preset size is a d×d square area and d is set to 4 and 16. According to the illustration of FIGS. 12A and 12B, it is possible to see that when the value of d increases, the sizes of object of non-interest areas increase, but the effect of spatial noise removal is improved.

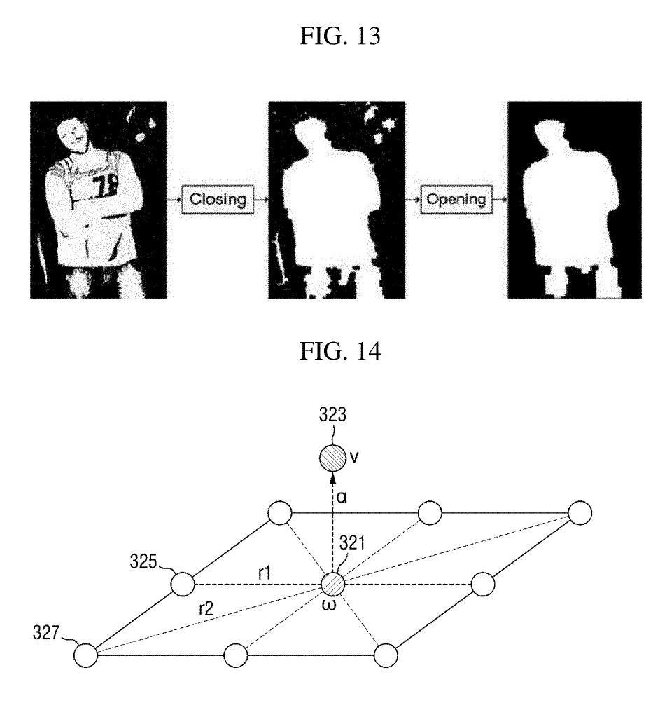

In addition, the first spatial noise remover 157a may perform a morphology operation to further improve the effect of spatial noise removal. The morphology operation may be performed through an erosion, dilation, closing, or opening calculation or a combination thereof. FIG. 13 shows an example in which an opening calculation is performed after a closing calculation.

Subsequently, the second spatial noise remover 157b removes spatial noise by using a Markov random field (MRF) model. Specifically, the second spatial noise remover 157b determines an object of non-interest area which minimizes an energy value of an energy function defined on the basis of the MRF model, thereby removing spatial noise. Since the MRF model is a probability model widely known in the corresponding technical field, detailed description thereof will be omitted.

FIG. 14 shows an MRF model used by the second spatial noise remover 157b.

Spatial noise removal using the MRF model may be performed in units of pixels or blocks. Referring to FIG. 14, assuming that an object of non-interest area is determined in units of blocks, a node 321 indicates a first block w of a video frame (or an object of non-interest area) which will be acquired as a result of spatial noise removal processing, a node 323 indicates a second block v corresponding to the first block w in a video frame from which a first motion vector is acquired, and nodes 325 and 327 indicate neighboring blocks of the first block w.

According to an exemplary embodiment of the present disclosure, the second spatial noise remover 157b may determine an object of non-interest area so that an energy value of an energy function of Equation 1 below may be minimized. Those of ordinary skill in the art should appreciate that a spatial noise removal process may be modeled into a problem of minimizing an energy value of an MRF-based energy function, and thus detailed description thereof will be omitted. Also, those of ordinary skill in the art should appreciate that Equation 1 below is defined on the basis of the MRF model shown in FIG. 14.

E=αEᵥ+E_{ω} [Equation 1]

In Equation 1 above, a first energy term Eᵥ indicates an energy term according to a relationship between the first block w and the second block v corresponding thereto, and a second energy term E_{w} indicates an energy term according to a relationship between the first block w and neighboring blocks adjacent thereto. Also, α indicates a scaling factor for adjusting a weight of an energy term. A method of calculating the energy value of each energy term will be described below.

According to an exemplary embodiment of the present disclosure, the first energy term Eᵥ may be calculated according to Equation 2 below. In Equation 2 below, Dᵥ(v, w) indicates a similarity between the first block w and the second block v corresponding thereto. In Equation 2 below, the minus sign denotes that a higher similarity between the two blocks indicates a smaller energy value of the first energy term.

Eᵥ^{f}=−Dᵥ^{f}(v,ω) [Equation 2]

In Equation 2 above, the similarity between the two blocks may be calculated by using a sum of squared difference (SSD), a sum of absolute difference (SAD), whether values (e.g., 1 indicates the presence of a motion vector, and 0 indicates the absence of a motion vector) indicating whether a motion vector exists (or whether the blocks correspond to an object of non-interest) coincide with each other, etc., but the similarity may be calculated by using any methods.

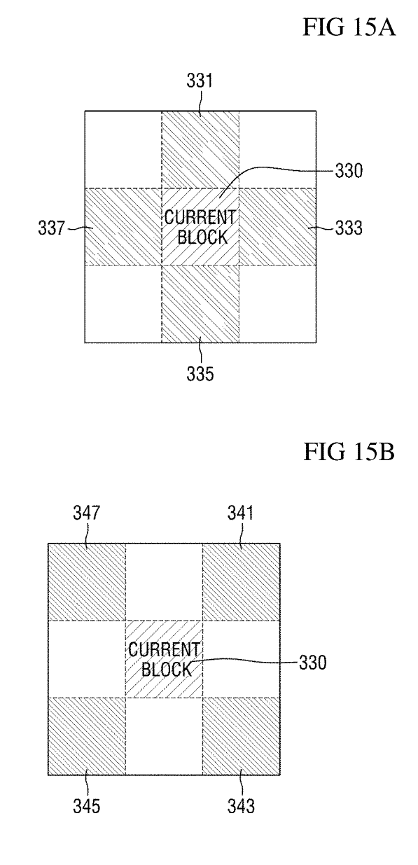

Subsequently, the energy value of the second energy term E_{w} may be calculated according to Equation 3 below in consideration of similarities between the corresponding block and neighboring blocks. This may be understood as using that when the neighboring blocks are classified as an object, the corresponding block is highly likely to be included in the object in consideration of a feature of a rigid body having a dense shape. In Equation 3 below, a 1^{st}-order neighboring block is a neighboring block positioned within a first distance and may be, for example, neighboring blocks 331 to 337 positioned on the up, down, left, and right sides of a current block 330 as shown in FIG. 15A, and a 2^{nd}-order neighboring block is a neighboring block positioned within a second distance longer than the first distance and may be, for example, neighboring blocks 341 to 347 positioned in a diagonal direction as shown in FIG. 15B. However, the 1^{st}-order neighboring block and the 2^{nd}-order neighboring block are not limited thereto.

$${E}_{ω} = - {γ}_{1} {\sum }_{{k ∈ 1 st - order}_{neighborhood}} {D}_{ω} ( {ω}_{k} , ω ) - {γ}_{2} {\sum }_{{k ∈ 2 nd - order}_{neighborhood}} {D}_{ω} ( {ω}_{k} , ω ) \qquad [ Equation 3 ]$$

According to an exemplary embodiment of the present disclosure, a coefficient γ₁ of an energy term for the 1^{st}-order neighboring block may be set to a larger value than a coefficient γ₂ of an energy term for the 2^{nd}-order neighboring block in Equation 3 above to give a higher weight to a similarity with the 1^{st}-order neighboring block which is at a closer distance. However, this may vary according to exemplary embodiments.

A solution to Equation 1 above may be determined by using an algorithm such as iterated conditional modes (ICM) and stochastic relaxation (SR). Since a process of calculating a solution to Equation 1 above is apparent to those of ordinary skill in the art, detailed description thereof will be omitted.

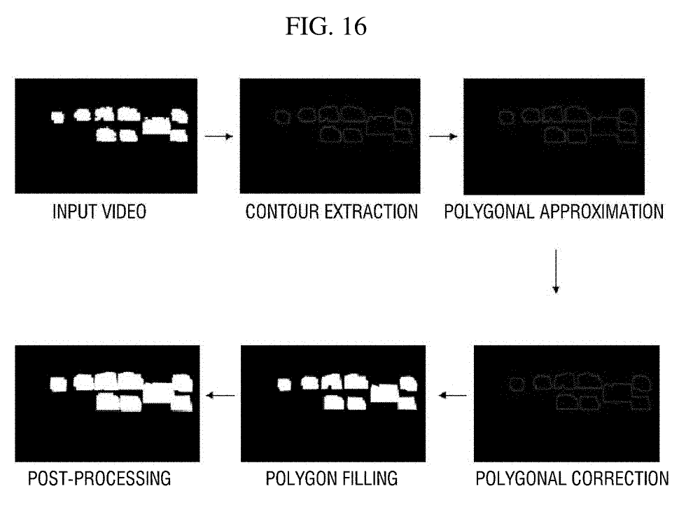

Subsequently, the third spatial noise remover 157c performs a spatial noise removal processing by using the contour of an object of non-interest extracted from the input video information. Specifically, the third spatial noise remover 157c performs a spatial noise removal processing according to a process shown in FIG. 16.

Referring to FIG. 16, the third spatial noise remover 157c extracts contours of object of non-interest areas from the input video information and performs a polygonal approximation on the basis of the extracted contours. Here, it is possible to use any algorithm for extracting a contour or any polygonal approximation algorithm.

Subsequently, the third spatial noise remover 157c performs contour correction on the basis of an angle among three points positioned on a contour. For example, when the angle among the three points is a threshold angle or less, correction may be performed to change a contour connecting the three points into a straight line. Here, three points positioned within a certain distance may be randomly selected, but a method of selecting three points is not limited thereto.

Subsequently, the third spatial noise remover 157c fills areas in the contours and performs post-processing by using morphology operation. Here, filling the areas in the contours may denote marking the areas in the contours to correspond to object of non-interest areas.

When the spatial noise removal processing is performed as described above, object of non-interest areas from which spatial noise has been removed are determined. For example, the spatial noise remover 157 determines the 3-1 object of non-interest area from which spatial noise has been removed on the basis of the 2-1 object of non-interest area from which temporal noise has been removed. Then, the mask generator 150-1 generates a mask corresponding to the 3-1 object of non-interest area and provides the generated mask to the object-of-interest detector 170.

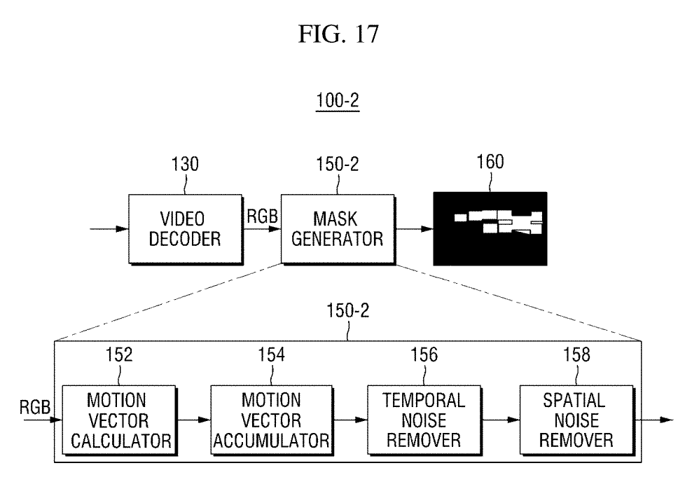

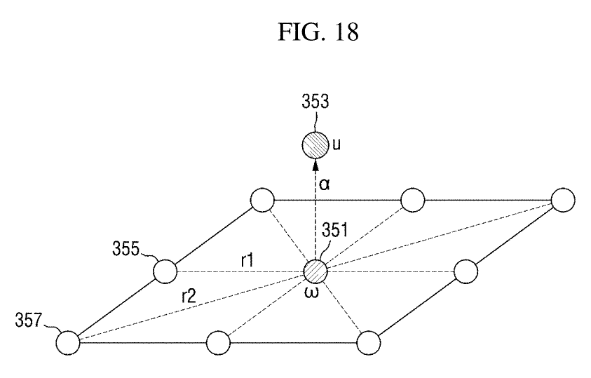

A configuration and operation of the masking apparatus 100-1 according to the first exemplary embodiment of the present disclosure have been described in detail above with reference to FIGS. 5 to 16. The masking apparatus 100-2 according to a second exemplary embodiment of the present disclosure will be described below with reference to FIGS. 17 and 18.

The masking apparatus 100-2 according to the second exemplary embodiment of the present disclosure determines an object of non-interest area by using a second motion vector calculated on the basis of an optical flow and generates a mask corresponding to the object of non-interest area. Not to reiterate the same description, the masking apparatus 100-2 according to the second exemplary embodiment will be continuously described, centering on differences from the masking apparatus 100-1 according to the first exemplary embodiment.

FIG. 17 is a block diagram of a mask generator 150-2 of the masking apparatus 100-2 according to the second exemplary embodiment.

Referring to FIG. 17, the mask generator 150-2 may be configured to include a motion vector calculator 152, a motion vector accumulator 154, a temporal noise remover 156, and a spatial noise remover 158.

Referring to each component, the motion vector calculator 152 calculates a second motion vector from video information input by using an optical flow. Here, the second motion vector may be obtained by using any of a dense optical flow technique and a sparse optical flow technique and any optical flow algorithm.

The motion vector accumulator 154 accumulates second motion vectors calculated for each frame. Operation of the motion vector accumulator 154 is similar to that of the motion vector accumulator 153 described above, and thus detailed description thereof will be omitted.

The temporal noise remover 156 removes temporal noise from the input video information. For example, the temporal noise remover 156 removes temporal noise from areas in which the second motion vectors are present (will be referred to as “1-2 object of non-interest areas” below) in the input video information and provides the areas from which temporal noise has been removed (will be referred to as “2-2 object of non-interest areas” below) as processing results. Detailed operation of the temporal noise remover 156 is similar to that of the temporal noise remover 155, and thus detailed description thereof will be omitted.

The spatial noise remover 158 removes spatial noise from the input video information. For example, the spatial noise remover 158 removes spatial noise from the 2-2 object of non-interest areas and provides the areas from which spatial noise has been removed (will be referred to as “3-2 object of non-interest areas” below) as processing results. However, when the mask generator 150-2 is configured not to include the temporal noise remover 156 according to an exemplary embodiment, the spatial noise remover 158 may remove spatial noise from the 1-2 object of non-interest areas.

Operation of the spatial noise remover 158 is similar to that of the spatial noise remover 157. However, there is a difference in that when the spatial noise remover 158 removes spatial noise by using an MRF model, the MRF model shown in FIG. 18 and Equation 4 derived from the MRF model are used.

Spatial noise removal using the MRF model may be performed in units of pixels or blocks. In FIG. 18, assuming that object of non-interest areas are determined in units of pixels, a node 351 indicates a first pixel w of a video frame (or an object of non-interest area) which will be acquired as a result of spatial noise removal processing, a node 353 indicates a second pixel v corresponding to the first pixel w in a video frame from which a second motion vector is acquired, and nodes 355 and 357 indicate neighboring pixels of the first pixel w.

In Equation 4 below, a first energy term Eᵤ indicates an energy term according to a relationship between the first block w and the second block u corresponding thereto, and a second energy term E_{w} indicates an energy term according to a relationship between the first block w and neighboring blocks adjacent thereto. Also, a indicates a scaling factor for adjusting a weight of an energy term. A method of calculating the energy value of each energy term is similar to that for Equation 1 above, and thus description thereof will be omitted.

E=αEᵤ+E_{ω} [Equation 4]

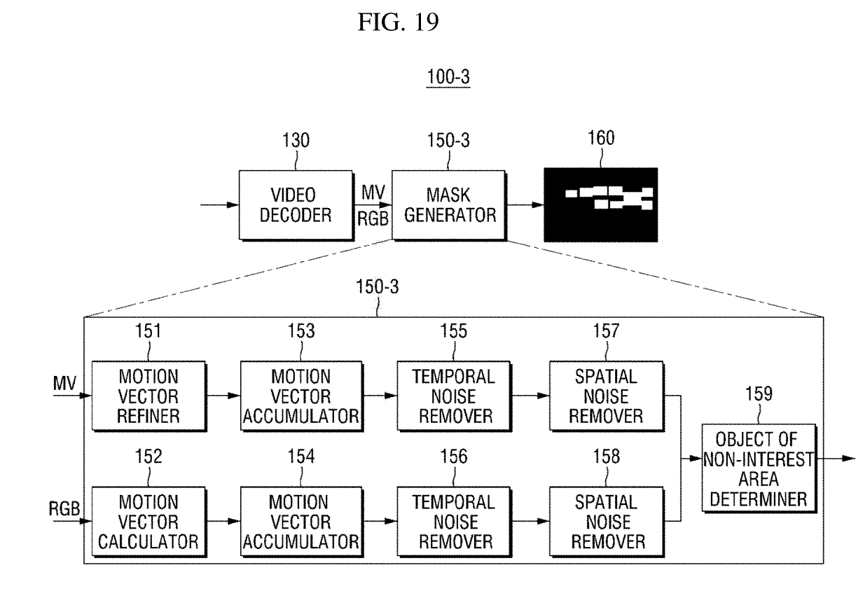

The masking apparatus 100-2 according to the second exemplary embodiment of the present disclosure has been described above with reference to FIGS. 17 and 18. Next, the masking apparatus 100-3 according to the third exemplary embodiment of the present disclosure will be described with reference to FIGS. 19 to 22.

The masking apparatus 100-3 according to the third exemplary embodiment of the present disclosure determines an object of non-interest area by using both a first motion vector and a second motion vector and generates a mask corresponding to the object of non-interest area. Therefore, the masking apparatus 100-3 may include some components of the first and second masking apparatuses 100-1 and 100-2 according to the first and second exemplary embodiments.

FIG. 19 is a block diagram of a mask generator 150-3 of the masking apparatus 100-3 according to the third exemplary embodiment of the present disclosure.

Referring to FIG. 19, the mask generator 150-3 may be configured to include all the components of the mask generator 15-1 and the mask generator 150-2 and further include an object of non-interest area determiner 159. Not to reiterate the same description, description of the components 151 to 158 of the mask generator 150-1 and the mask generator 150-2 will be omitted.

The object of non-interest area determiner 159 may determine final object of non-interest areas by using object of non-interest areas determined on the basis of first motion vectors and object of non-interest areas determined on the basis of second motion vectors. For convenience of description, in this exemplary embodiment, the object of non-interest areas determined on the basis of the first motion vectors will be collectively referred to as first object of non-interest areas, and the object of non-interest areas determined on the basis of the second motion vectors will be collectively referred to as second object of non-interest areas.

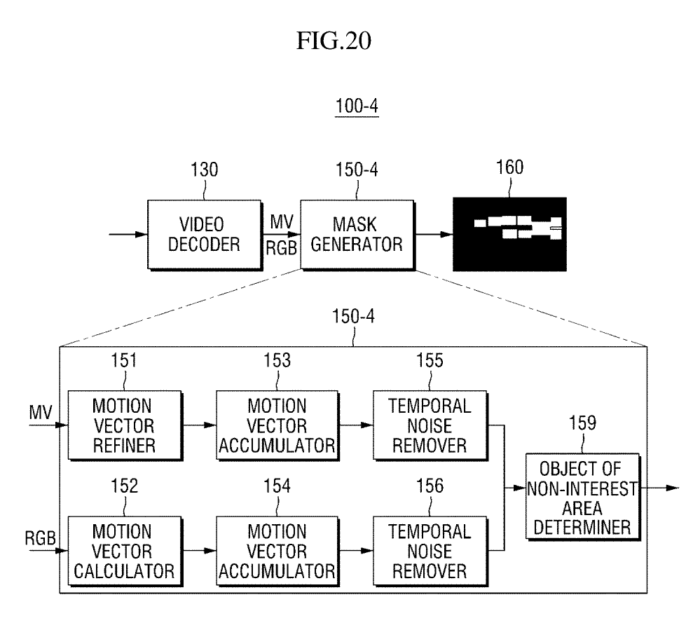

FIG. 19 shows an example of determining final object of non-interest areas on the basis of 3-1 object of non-interest areas provided by the spatial noise remover 157 and 3-2 object of non-interest areas provided by the spatial noise remover 158. However, as shown in FIG. 20, some components, such as the spatial noise removers 157 and 158, may be excluded.

The object of non-interest area determiner 159 combines the first object of non-interest areas and the second object of non-interest areas by using an MRF model and determines final object of non-interest areas. As a preprocessing process therefor, the object of non-interest area determiner 159 may match units for calculating first motion vectors in the first object of non-interest areas and units for calculating second motion vectors in the second object of non-interest areas to each other. For example, when first motion vectors are calculated in units of blocks and second motion vectors are calculated in units of pixels, the object of non-interest area determiner 159 may match the calculation units on the basis of block units.

Referring to the detailed matching process, the object of non-interest area determiner 159 groups pixels included in the second object of non-interest areas into respective blocks. Here, the positions and sizes of the respective blocks correspond to unit blocks from which first motion vectors are calculated in the first object of non-interest areas. Subsequently, the object of non-interest area determiner 159 marks blocks in which the number of pixels at which motion vectors are detected is a threshold value or more as blocks in which a motion vector exists, thereby matching the calculation units.

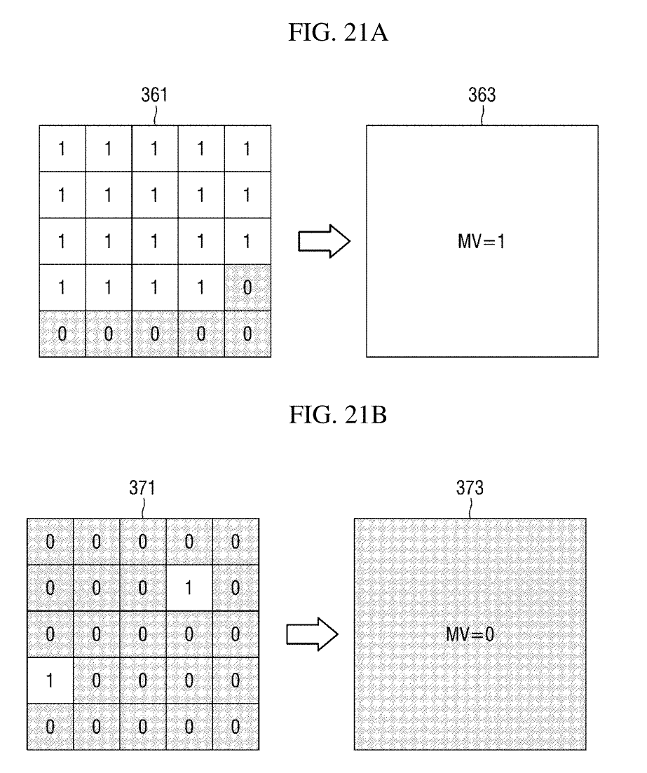

Examples thereof are shown in FIGS. 21A and 21B. FIGS. 21A and 21B show examples of matching calculation units when the size of unit blocks from which first motion vectors are calculated is 4×4 and the threshold value is 9. Specifically, FIG. 21A shows a case in which a specific block 361 of a second object of non-interest area is marked as having a motion vector therein, and FIG. 21B shows a case in which a specific block 371 is marked as having no motion vector therein.

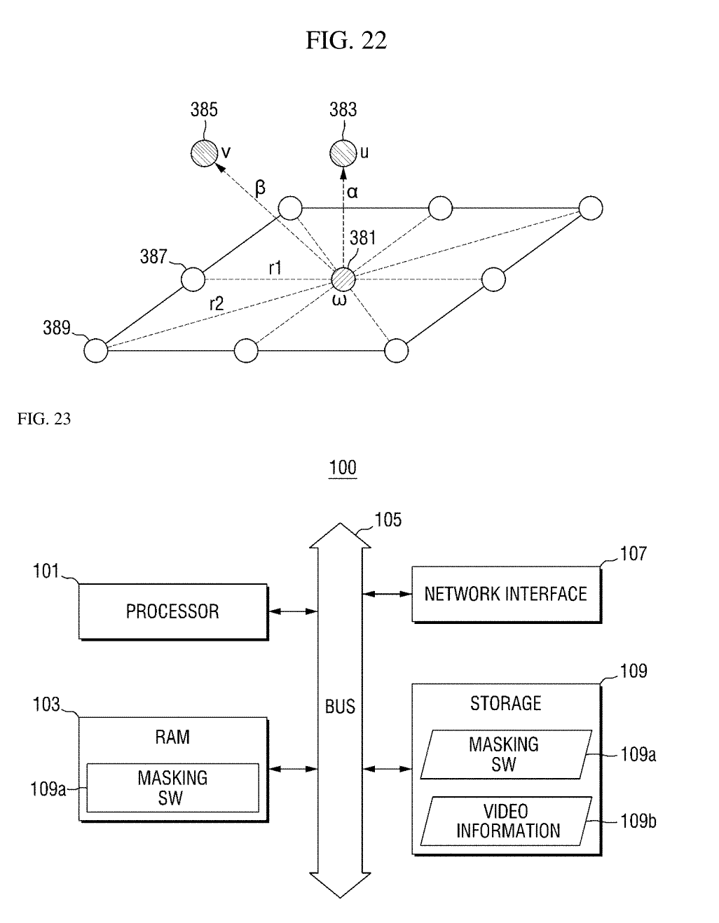

When motion vector calculation units are matched according to the above-described operation, the object of non-interest area determiner 159 combines the first object of non-interest areas and the second object of non-interests by using Equation 5 below, which is derived from the MRF model shown in FIG. 22, and determines final object of non-interest areas. Specifically, the object of non-interest area determiner 159 determines the final object of non-interest areas so that an energy value of an energy function of Equation 5 below may be minimized. This operation may also be considered as a spatial noise removal processing.

E=αEᵥ+βEᵤ+E_{ω} [Equation 5]

In the MRF model shown in FIG. 22, a node 381 indicates a first block w of a video frame (or an object of non-interest area) which will be acquired as a result of spatial noise removal processing, and a node 385 indicates a second block v corresponding to the first block w in a video frame from which a first motion vector is acquired. Also, a node 383 indicates a third block u corresponding to the first block w in a video frame from which a second motion vector is acquired, and nodes 387 and 389 indicate neighboring blocks of the first block w.

In Equation 5 above, a first energy term Eᵥ indicates an energy term according to a relationship between the first block w and the second block v corresponding thereto, a second energy term Eᵤ indicates an energy term according to a relationship between the first block w and the third block u corresponding thereto, and a third energy term E_{w} indicates an energy term according to a relationship between the first block w and neighboring blocks adjacent thereto. Also, α and β indicate scaling factors for adjusting weights of energy terms. A method of calculating the energy value of each energy term is similar to those of Equation 1 and Equation 3 above, and thus description thereof will be omitted.

Meanwhile, it has been described above that the object of non-interest area determiner 159 shown in FIG. 19 or 20 determines final object of non-interest areas on the basis of first object of non-interest areas and second object of non-interest areas from which temporal noise or spatial noise has been removed. However, according to another exemplary embodiment of the present disclosure, before a temporal or spatial noise removal processing is performed, two object of non-interest areas may be combined by the object of non-interest area determiner 159, and temporal noise and/or spatial noise may be removed from the combined object of non-interest area.

The masking apparatuses 100-1 to 100-4 according to the first to third exemplary embodiments of the present disclosure have been described above with reference to FIGS. 3 to 22. Next, a masking apparatus 100 for an object of non-interest according to another exemplary embodiment of the present disclosure will be described with reference to FIG. 23.

FIG. 23 is a diagram showing a hardware configuration of the masking apparatus 100 according to another exemplary embodiment of the present disclosure.

Referring to FIG. 23, the masking apparatus 100 for an object of non-interest may include at least one processor 101, a bus 105, a network interface 107, a memory 103 into which a computer program executed by the processor 101 is loaded, and a storage 109 for storing a masking software 109a for an object of non-interest. However, only components related to exemplary embodiments of the present disclosure are shown in FIG. 23. Therefore, those of ordinary skill in the art to which the present disclosure pertains should appreciate that general-purpose components other than those shown in FIG. 23 may also be included.

The processor 101 controls overall operation of each component of the masking apparatus 100 for an object of non-interest. The processor 101 may be configured to include a central processing unit (CPU), a microprocessor unit (MPU), a micro controller unit (MCU), a graphics processing unit (GPU), or any form of processor widely known in the technical field of the present disclosure. Also, the processor 101 may perform calculation for at least one application or program for executing methods according to exemplary embodiments of the present disclosure. The masking apparatus 100 for an object of non-interest may have one or more processors.

The memory 103 stores various kinds of data, commands, and/or information. One or more programs 109a may be loaded from the storage 109 into the memory 103 so that methods of masking an object of non-interest according to exemplary embodiments of the present disclosure are performed. In FIG. 23, a random access memory (RAM) is shown as an example of the memory 103.

The bus 105 provides a communication function between components of the masking apparatus 100 for an object of non-interest. The bus 105 may be implemented in various forms, such as an address bus, a data bus, and a control bus.

The network interface 107 supports wired or wireless Internet communication of the masking apparatus 100 for an object of non-interest. Also, the network interface 107 may support various communication methods in addition to Internet communication. To this end, the network interface 107 may be configured to include a communication module widely known in the technical field of the present disclosure.

The storage 109 may non-temporarily store the one or more programs and video information 109b. In FIG. 23, the masking software 109a for an object of non-interest is shown as an example of the one or more programs.

The storage 109 may be configured to include a non-volatile memory, such as a read-only memory (ROM), an erasable programmable ROM (EPROM), an electrically erasable programmable ROM (EEPROM), and a flash memory, a hard disk, a detachable disk, or any form of computer-readable recording medium widely known in the technical field of the present disclosure.

A method of masking an object of non-interest according to an exemplary embodiment of the present disclosure may be performed by the masking software 109a for an object of non-interest. For example, the masking software 109a may be loaded into the memory 103 and perform, through the at least one processor 101, an operation of acquiring a motion vector for an object of non-interest included in first video information and determining an area from which the motion vector is acquired in the first video information as a first object of non-interest area, an operation of removing spatial noise from the first object of non-interest area and acquiring a second object of non-interest area, at least a part of which is different from the first object of non-interest area, as a result of the spatial noise removal, and an operation of generating a mask corresponding to the second object of non-interest area.

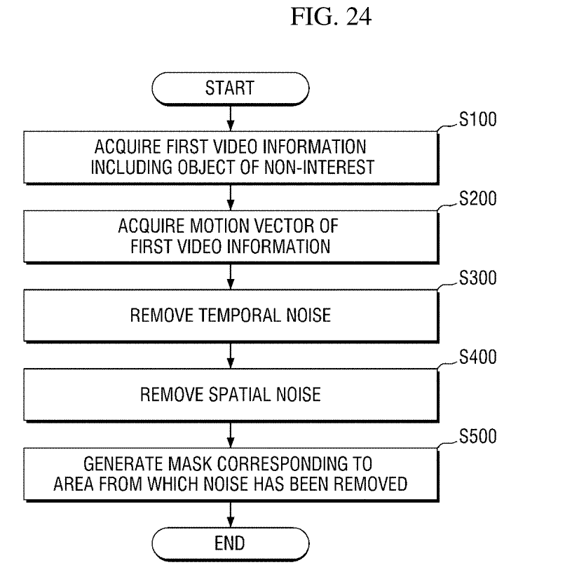

A hardware configuration of the masking apparatus 100 for an object of non-interest according to an exemplary embodiment of the present disclosure has been described above with reference to FIG. 23. Next, a method of masking an object of non-interest according to an exemplary embodiment of the present disclosure will be described in detail with reference to FIGS. 24 to 28.

Each operation of a method of masking an object of non-interest described below according to an exemplary embodiment of the present disclosure may be performed by a computing apparatus. For example, the computing apparatus may be the masking apparatus 100 according to an exemplary embodiment of the present disclosure. However, a subject which performs each operation included in the masking method may be omitted for convenience of description. Also, each operation of the masking method may be implemented as an operation of the masking software 109a executed by the processor 101 of the masking apparatus 100.

The method of masking an object of non-interest according to an exemplary embodiment of the present disclosure may include a mask generation method of generating a mask on the basis of first video information and an object-of-interest detection method of detecting an object of interest in second video information by using the generated mask. First, the mask generation method will be described with reference to FIGS. 24 to 26. Detailed descriptions which are the same as or correspond to the exemplary embodiments described with reference to FIGS. 3 to 23 will be omitted below.

FIG. 24 is a flowchart of a mask generation method according to an exemplary embodiment of the present disclosure. However, this is only an exemplary embodiment for achieving an object of the present disclosure, and some operations may be added or omitted as necessary.

Referring to FIG. 24, in operation S100, first video information including an object of non-interest is acquired. For example, the first video information may be a plurality of video frames received in real time from the video capturing apparatus 200 which films a designated region of interest. Also, the first video information may be encoded video information in the form of a bitstream.

In operation S200, a motion vector of the first video information is acquired. Also, an area in which the acquired motion vector is present in the first video information is determined as a first object of non-interest area.

In an exemplary embodiment, the acquired motion vector may be a first motion vector which is calculated in a process of encoding the first video information. The first motion vector may be directly acquired in a process of decoding the first video information received in the form of a bitstream. However, the first motion vector is highly likely to include noise, and thus a certain refining operation may be additionally performed. This has been described above in connection with the motion vector refiner 151.

In an exemplary embodiment, the acquired motion vector may be a second motion vector which is calculated on the basis of an optical flow.

In some exemplary embodiments, motion vectors may be accumulated over a preset number of frames, and an area in which the motion vectors are accumulated may be determined as the first object of non-interest area. This has been described in detail above in connection with the motion vector accumulators 153 and 154.

In operation S300, temporal noise is removed from the first object of non-interest area. As a result of the temporal noise removal processing, a second object of non-interest area is acquired. This has been described in detail above in connection with the temporal noise removers 155 and 156.

In operation S400, spatial noise is removed from the second object of non-interest area, and a third object of non-interest area is acquired as a result of the spatial noise removal processing. This has been described in detail above in connection with the spatial noise removers 157 and 158.

In an exemplary embodiment, the spatial noise removal processing may be performed by expanding areas in units of pixels as shown in FIG. 25. Specifically, in operation S411, an area expansion processing of expanding each pixel area included in the second object of non-interest area to a neighboring pixel area having a preset size is performed, and in operation S413, morphology operation may be additionally performed.

In an exemplary embodiment, the spatial noise removal processing may be performed by finding a solution for minimizing an energy value of an energy function defined on the basis of an MRF model.

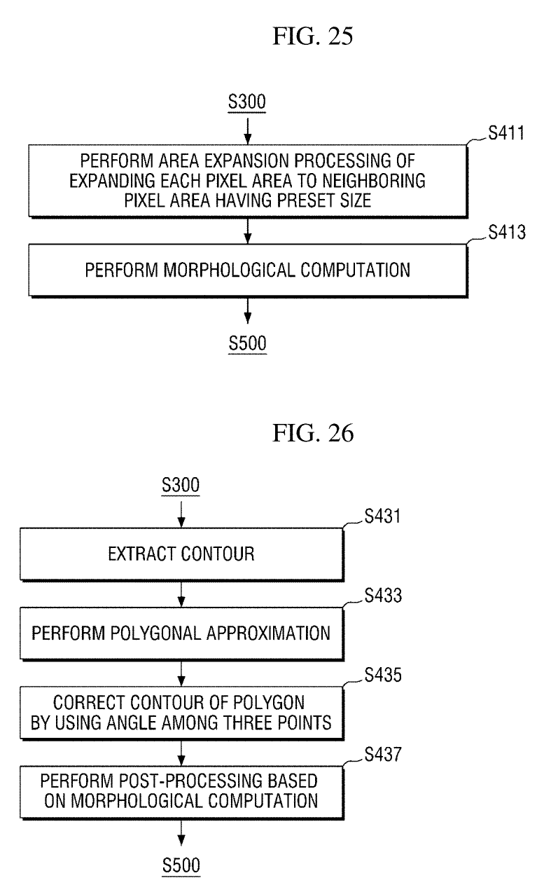

In an exemplary embodiment, the spatial noise removal processing may be performed on the basis of the contour of the second object of non-interest area as shown in FIG. 26. This has been described above, and thus description thereof will be omitted not to reiterate the same description.

In operation S500, a mask corresponding to the third object of non-interest area is generated. The generated mask may be used later to accurately detect an object of interest.

A mask generation method according to an exemplary embodiment of the present disclosure has been described above with reference to FIGS. 24 to 26. An object-of-interest detection method according to an exemplary embodiment of the present disclosure will be briefly described below with reference to FIGS. 27 and 28.

FIG. 27 is a flowchart of an object-of-interest detection method according to an exemplary embodiment of the present disclosure. However, this is merely an exemplary embodiment for achieving objects of the present disclosure, and some operations may be added or removed as necessary.

Referring to FIG. 27, in operation S600, second video information including an object of interest and objects of non-interest is acquired.

In operation S700, object-of-interest detection is performed on the second video information by using masks of the objects of non-interest generated on the basis of first video information. Specifically, a feature which represents the object of interest is detected in an area of the second video information except for areas corresponding to the masks. Here, the feature which represents the object of interest may be, for example, a motion vector.

In operation S800, it is determined whether the object of interest has been detected to be adjacent to object of non-interest areas. For example, the determination may be made based on whether the feature representing the object of interest is detected within a preset threshold distance from the object of non-interest areas.

When it is determined that the object of interest is detected to be adjacent to an object of non-interest area, it is determined in operation S900 whether to exclude a mask corresponding to the object of non-interest area. In other words, to prevent a problem that a part of the object of interest is covered by the mask and is not detected, it is determined in operation S900 whether to exclude the corresponding mask according to certain criteria of judgement. However, according to exemplary embodiments, it is possible to directly exclude the corresponding mask without performing the determining operation S900. Operation S900 will be described below with reference to FIG. 28.

When it is determined to exclude the corresponding mask, the object of interest is detected by using only other masks in operation S1000. For example, when there are a plurality of masks corresponding to the respective object of non-interest areas, only a mask adjacent to the object of interest may be excluded, and the object of interest may be detected by using only other masks.

When it is determined not to exclude the corresponding mask, the object of interest is detected by using all the masks.

Operation S900 will be described in further detail below with reference to FIG. 28.

Referring to FIG. 28, in operation S910, motion vector patterns of the object of non-interest area and the object of interest which are adjacent to each other are calculated. The motion vector patterns may be generated on the basis of lengths, directions, etc. of motion vectors. Information representing a corresponding area, such as an average length and an average direction of motion vectors, may be generated as a pattern.

In operation S930, the two patterns are compared with each other.

When a comparison result indicates that the two patterns are similar, the corresponding mask is excluded in operation S950. This is because when the two patterns are similar, a motion vector shown in the adjacent object of non-interest area is highly likely to have a feature representing the same object of interest. Also, in operation S1000, the object of interest is detected by using only other masks.

Otherwise, in operation S970, the corresponding mask is not excluded. Also, in operation S1100, object detection is performed by using all the masks.

An object-of-interest detection method according to an exemplary embodiment of the present disclosure has been described above with reference to FIGS. 27 and 28. According to the above description, when an object of interest is detected to be adjacent to a specific object of non-interest area, a mask corresponding to the adjacent area may be excluded according to certain criteria of judgement, and the object of interest may be detected. Accordingly, it is possible to solve a problem that an object of interest is not accurately detected due to a mask, and to improve accuracy in object-of-interest detection.

A method of masking an object of non-interest according to an exemplary embodiment of the present disclosure has been described above with reference to FIGS. 24 to 28. According to the above description, using a mask for an object of non-interest may prevent an object of non-interest from being misdetected as an object of interest. Accordingly, accuracy in object-of-interest detection may be improved.

Also, object of non-interest areas may be automatically determined from input video information, and mask corresponding to the object of non-interest areas may be generated. Accordingly, even when a region of interest is changed, automatic masking is performed without intervention of a manager such that a user's convenience may be improved. Further, with the improvement of accuracy in object-of-interest detection, reliability of intelligent video analysis information may be improved.

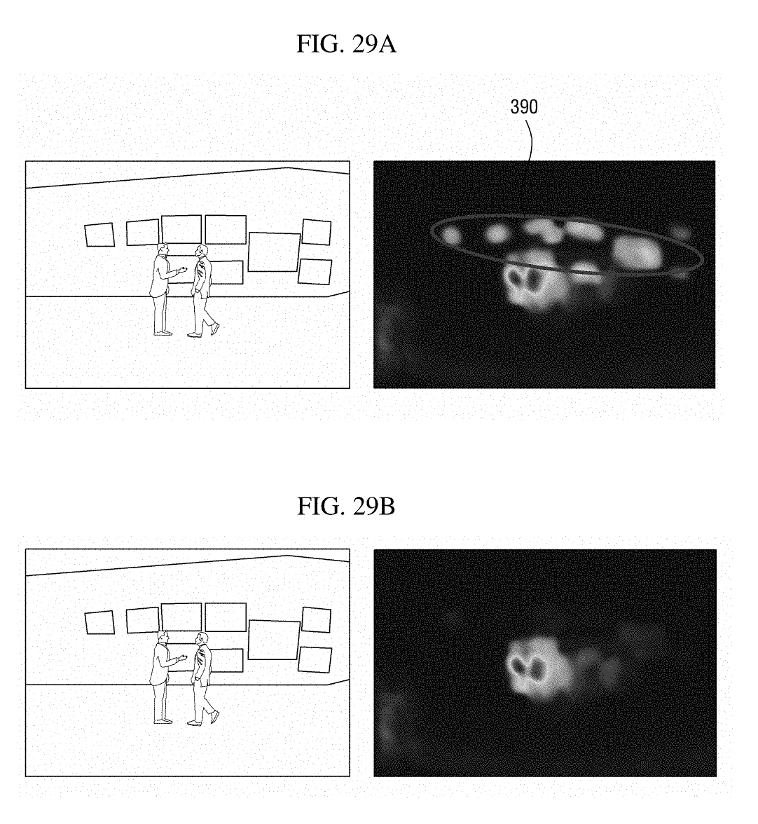

A result of the above-described method of masking an object of non-interest will be briefly described below with reference to FIGS. 29A and 29B.

FIGS. 29A and 29B show original images of a display store, which is a region of interest, on the left side and show heat maps which visualize customers' lines of flow detected in information on the images on the right side. FIG. 29A shows a case in which masking has not been performed, and FIG. 29B shows a case in which masking has been performed according to an exemplary embodiment of the present disclosure.

Referring to FIG. 29A, it is possible to see that when display apparatuses which are objects of non-interest are not masked, movement 390 in videos, which are being played by the display apparatuses, is shown together with movement of customers in the heat map. In other words, it is possible to see that the display apparatuses are misdetected as customers.

Next, referring to FIG. 29B, it is possible to see that masking prevents the display apparatuses from being misdetected as objects of interest and results in accurate detection of movement of the customers, who correspond to objects of interest, in the heat map. This means that a mask generated according to an exemplary embodiment of the present disclosure accurately covers an object of non-interest area and it is possible to accurately detect only an object of interest in a given video by using the mask.

According to the above-described present disclosure, an object of non-interest area may be automatically determined from input video information, and a mask corresponding to the object of non-interest area may be generated. Accordingly, even when a region of interest is changed, automatic masking is performed without intervention of a manager such that a user's convenience may be improved.

Object-of-interest detection is performed by using a generated mask. Accordingly, it is possible to prevent an object of non-interest from being detected as an object of interest, and accuracy in object-of-interest detection may be improved.

Since the accuracy in object-of-interest detection is improved, it is possible to improve the reliability of intelligent video analysis information.

When an object of non-interest area is determined on the basis of a motion vector, temporal noise and/or spatial noise is removed from the object of non-interest area, and thus a mask accurately corresponding to the object of non-interest area may be generated. Accordingly, the accuracy in object-of-interest detection may be further improved.

When an object of interest is detected to be adjacent to a specific object of non-interest area, object-of-interest detection may be performed according to certain criteria of judgement, excluding a mask corresponding to the adjacent area. Accordingly, it is possible to solve a problem that an object of interest is not accurately detected due to a mask and to improve the accuracy in object-of-interest detection.

Effects of the present disclosure are not limited to those mentioned above, and other effects which have not been mentioned can be clearly understood by those of ordinary skill in the art from the above description.

The concepts of the disclosure described above with reference to FIGS. 2 to 29B can be embodied as computer-readable code on a computer-readable medium. The computer-readable medium may be, for example, a removable recording medium (a CD, a DVD, a Blu-ray disc, a USB storage device, or a removable hard disc) or a fixed recording medium (a ROM, a RAM, or a computer-embedded hard disc). The computer program recorded on the computer-readable recording medium may be transmitted to another computing apparatus via a network such as the Internet and installed in the computing apparatus. Hence, the computer program can be used in the computing apparatus.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

While the present disclosure has been particularly illustrated and described with reference to exemplary embodiments thereof, it will be understood by those of ordinary skill in the art that various changes in form and detail may be made therein without departing from the spirit and scope of the present disclosure as defined by the following claims. The exemplary embodiments should be considered in a descriptive sense only and not for purposes of limitation.

What is claimed is:

1. A method of masking an object of non-interest by a masking apparatus, the method comprising:
acquiring first video information of a region of interest;
determining a first object of non-interest area as an area in which motion vectors are present in the first video information of the region of interest;
removing spatial noise from the first object of non-interest area to acquire a second object of non-interest area including at least a part of the first object of non-interest area; and
generating a mask corresponding to the second object of non-interest area.

2. The method of claim 1, wherein the determining the first object of non-interest area comprises:
acquiring a video bitstream of the first video information generated through an encoding process;
decoding the video bitstream and acquiring motion vectors calculated in the encoding process as a result of the decoding; and
determining the first object of non-interest area based on the acquired motion vectors.

3. The method of claim 2, wherein the determining the first object of non-interest area based on the acquired motion vectors comprises determining the first object of non-interest area based on the acquired motion vectors except for a motion vector satisfying a preset condition,
wherein the preset condition includes at least one from among a first condition that a length of a motion vector is less than or equal to a first threshold value and a second condition that a length of a motion vector greater than or equal to a second threshold value, which is greater than the first threshold value.

4. The method of claim 1, wherein the determining the first object of non-interest area comprises:
calculating a motion vector of the first video information by using an optical flow; and
determining an area in which the calculated motion vector is present in the first video information as the first object of non-interest area.

5. The method of claim 1, wherein the first video information comprises a plurality of video frames, and
wherein the determining the first object of non-interest area comprises:
accumulating motion vectors acquired from the plurality of video frames, respectively; and
determining the first object of non-interest area based on the accumulated motion vectors.

6. The method of claim 5, wherein the determining the first object of non-interest area based on the accumulated motion vectors comprises determining the first object of non-interest area based on the accumulated motion vectors except for a motion vector satisfying a preset condition, and
wherein the preset condition includes a condition that an average length of the motion vectors of the plurality of video frames is less than or equal to a threshold value.

7. The method of claim 1, wherein the acquiring the second object of non-interest area comprises performing an area expansion processing of expanding each pixel area included in the first object of non-interest area to a neighboring pixel area having a preset size.

8. The method of claim 7, wherein the acquiring the second object of non-interest area comprises performing a morphology operation on a result of the area expansion processing.

9. The method of claim 1, wherein the acquiring the second object of non-interest area comprises removing spatial noise from the first object of non-interest area so that an energy value of an energy function based on a Markov random field (MRF) model is minimized, and acquiring the second object of non-interest area as a result of the spatial noise removal processing.

10. The method of claim 9, wherein the energy function includes a first energy term based on a first similarity between a first area included in the first object of non-interest area and a second area included in the second object of non-interest area corresponding to the first area, and a second energy term based on a second similarity between a third area included in the second object of non-interest area and a first neighboring area of the third area.

11. The method of claim 10, wherein an energy value of the second energy term is determined based on a third similarity between the third area and a second neighboring area positioned within a first distance from the third area, and a fourth similarity between the third area and a third neighboring area positioned within a second distance from the third area,
wherein the first distance is shorter than the second distance.

12. The method of claim 11, wherein the energy value of the second energy term is determined to be a weighted sum of the third similarity and the fourth similarity, and
wherein a first weight given to the third similarity is greater than a second weight given to the fourth similarity.

13. The method of claim 1, wherein the determining the first object of non-interest area comprises:
decoding a video bitstream obtained by encoding the first video information and acquiring a first motion vector calculated in a process of encoding the first video information as a result of the decoding;
determining a 1-1 object of non-interest area in the first video information based on the first motion vector;
calculating a second motion vector of the first video information based on an optical flow; and
determining a 1-2 object of non-interest area in the first video information based on the second motion vector,
wherein the acquiring the second object of non-interest area comprises acquiring the second object of non-interest area by removing spatial noise from the 1-1 object of non-interest area and the 1-2 object of non-interest area.

14. The method of claim 13, wherein the acquiring the second object of non-interest area by removing the spatial noise from the 1-1 object of non-interest area and the 1-2 object of non-interest area comprises acquiring the second object of non-interest area by combining the 1-1 object of non-interest area and the 1-2 object of non-interest area so that an energy value of an energy function based on a Markov random field (MRF) model is minimized.

15. The method of claim 14, wherein the energy function includes a first energy term based on a first similarity between a 1-1 area included in the 1-1 object of non-interest area and a 2-1 area of the second object of non-interest area corresponding to the 1-1 area, and a second energy term based on a second similarity between a 1-2 area included in the 1-2 object of non-interest area and a 2-2 area of the second object of non-interest area corresponding to the 1-2 area.

16. The method of claim 1, wherein the acquiring the second object of non-interest area comprises:
extracting a contour of the first object of non-interest area;
correcting the contour by using an angle among three points positioned on the contour; and
determining an area indicated by the corrected contour as the second object of non-interest area.

17. The method of claim 16, wherein the correcting the contour comprises:
performing polygonal approximation on the extracted contour to acquire a first contour indicating a polygonal area; and
correcting the first contour by using an angle among three points positioned on the first contour,
wherein the determining of the second object of non-interest area comprises determining an area indicated by the corrected first contour as the second object of non-interest area.

18. The method of claim 16, wherein the determining the second object of non-interest area comprises performing a morphology operation on the area indicated by the corrected contour to determine the second object of non-interest area.

19. The method of claim 1, further comprising:
acquiring second video information of the region of interest; and
detecting an object of interest in the second video information by using the generated mask.

20. The method of claim 19, wherein the detecting the object of interest comprises, based on determining that a feature representing the object of interest is detected in a second area of the second video information adjacent to a first area covered by the generated mask, detecting the object of interest in the second video information except for the generated mask.

21. The method of claim 20, wherein the feature representing the object of interest is a motion vector, and
the detecting the object of interest in the second video information except for the generated mask comprises:
determining whether to exclude the generated mask based on a result of comparing a first pattern of a motion vector shown in the first area and a second pattern of a motion vector shown in the second area; and
detecting the object of interest in the second video information except for the generated mask based on the determining to exclude the generated mask.

22. A method of masking an object of non-interest by a masking apparatus, the method comprising:
acquiring a plurality of video frames of a region of interest;
accumulating motion vectors acquired from the plurality of video frames, respectively, and determining a first object of non-interest area as an area in which the accumulated motion vectors are present;
removing temporal noise from the first object of non-interest area based on lengths of the motion vectors to acquire a second object of non-interest area including at least a part of the first object of non-interest area; and
generating a mask corresponding to the second object of non-interest area.
